(19) United States
(12) Patent Application Publication
(10) Pub. No.: US 2021/0366355 A1
(43) Pub. Date: Nov. 25, 2021

(54) SOURCE DRIVER

(71) Applicant: TCL CHINA STAR OPTOELECTRONICS TECHNOLOGY CO., LTD., Shenzhen (CN)

(72) Inventor: Xiaoli FU, Shenzhen (CN)

(73) Assignee: TCL CHINA STAR OPTOELECTRONICS TECHNOLOGY CO., LTD., Shenzhen (CN)

(21) Appl. No.: 16/622,944

(22) PCT Filed: Dec. 11, 2019
(86) PCT No.: PCT/CN2019/124435

§ 371 Date: Dec. 16, 2019

(30) Foreign Application Priority Data
Nov. 29, 2019 (CN) 201911198458.1

(51) Int. Cl. G09G 3/20

(52) U.S. Cl. CPC G09G 3/2092; G09G 2330/06

(57) ABSTRACT

The present invention provides a source driver. The source driver includes an output terminal. The output terminal includes multiple effective output terminals and multiple dummy terminals. The effective output terminals constitute multiple effective output terminal groups. The dummy terminals constitute multiple dummy terminal groups. The effective output terminal groups are spaced apart by the dummy terminal groups. In the source driver of the present invention, the source outputs are divided into groups by setting virtual terminals, so that an electro-magnetic interference (EMI) test can be passed, and waste can be avoided.

### 1. FIELD OF DISCLOSURE

The present disclosure relates to a field of display technology and in particular, to a source driver.

### 2. DESCRIPTION OF RELATED ART

Generally, a driving device of a display panel includes a source driver, and the source driver transmits data signals in the display panel. In order to reduce the electro-magnetic interference (EMI) energy in the driving device, the source driver internally divides source outputs into different groups to be sent out, and the groups are staggered in time. When the source outputs are divided into more groups, the energy is more dispersed, and the EMI energy is lower, so it is easier to pass an EMI test. If there are only four groups, and the energy is concentrated in a low frequency band, the EMI test fails. If the source outputs are divided into 10 groups, the energy is relatively dispersed, and the EMI test is passed. However, by conventional designs, when there are more groups, a size of the source driver is larger, thus leading to a waste of space and costs.

Taking high definition (HD) resolution as an example, the source driver has 1,440 channels in total, but in fact there are only 1368 channels connected to the panel. In most conventional techniques, the left and right channels are connected to the panel, and virtual channels are in the middle; or virtual channels are on the left and right, and the middle channels are connected to the panel. For example, all 1368 source outputs are divided into 4 groups, and the groups are separated by a delay unit between them. However, if the source outputs are divided into more groups (e.g. 10 groups) by a conventional design, the source driver has a larger size, which obviously causes a waste of space.

In conventional techniques, if source outputs are divided into a small number of groups, the EMI test fails; but if the source outputs are divided into more groups, it results in a waste of space.

### SUMMARY

The present invention provides a source driver, whereby source outputs are divided into groups to make an electro-magnetic interference (EMI) test passed and also avoid waste without changing a size of the source driver.

The present invention provides a source driver, comprising: an output terminal comprising a plurality of effective output terminals and a plurality of dummy terminals, wherein the effective output terminals constitute a plurality of effective output terminal groups, the dummy terminals constitute a plurality of dummy terminal groups, and the effective output terminal groups are spaced apart by the dummy terminal groups;

wherein a number of the effective output terminal groups is greater than a number of the dummy terminal groups, and a number of the effective output terminals is greater than a number of the dummy terminals.

In the source driver according to one embodiment of the present invention, some of the effective output terminal groups have a same number of the effective output terminals.

In the source driver according to one embodiment of the present invention, some of the dummy terminal groups have a same number of the dummy terminals.

In the source driver according to one embodiment of the present invention, the number of the effective output terminal groups is greater than four.

In the source driver according to one embodiment of the present invention, the number of the effective output terminal groups is six, eight, or ten.

In the source driver according to one embodiment of the present invention, the number of the dummy terminal groups is one less than the number of the effective output terminals.

In the source driver according to one embodiment of the present invention, the number of the dummy terminal groups is five, seven, or nine.

In the source driver according to one embodiment of the present invention, all the effective output terminals are divided equally among the effective output terminal groups, or, if indivisible, the number of the effective output terminals in the last effective output terminal group is reduced; all the dummy terminals are divided equally among the dummy terminal groups, or, if indivisible, the number of the dummy terminals is reduced in the last dummy terminal group; and the number of the effective output terminals in each effective output terminal group and the number of the dummy terminals in each dummy terminal group are both an integer.

The present embodiment further provides a source driver. The source driver comprises an output terminal comprising a plurality of effective output terminals and a plurality of dummy terminals, wherein the plurality of effective output terminals constitute a plurality of effective output terminal groups, the dummy terminals constitute a plurality of dummy terminal groups, and the effective output terminal groups are spaced apart by the dummy terminal groups.

In the source driver according to one embodiment of the present invention, a number of the effective output terminal groups is greater than a number of the dummy terminal groups.

In the source driver according to one embodiment of the present invention, some of the effective terminal groups have a same number of the effective output terminals.

In the source driver according to one embodiment of the present invention, some of the dummy terminal groups have a same number of the dummy terminals.

In the source driver according to one embodiment of the present invention, a number of the effective output terminals is greater than a number of the dummy terminals.

In the source driver according to one embodiment of the present invention, a number of the effective output terminal groups is greater than four.

In the source driver according to one embodiment of the present invention, a number of the effective output terminal groups is six, eight, or ten.

In the source driver according to one embodiment of the present invention, a number of the dummy terminal groups is one less than a number of the effective output terminals.

In the source driver according to one embodiment of the present invention, a number of the dummy terminal groups is five, seven, or nine.

In the source driver according to one embodiment of the present invention, all the effective output terminals are divided equally among the effective output terminal groups, or, if indivisible, a number of the effective output terminals in the last effective output terminal group is reduced; all the dummy terminals are divided equally among the dummy terminal groups, or, if indivisible, a number of the dummy terminals in the last dummy terminal group is reduced; and a number of the effective output terminals in each effective output terminal group and a number of the dummy terminals in each dummy terminal group are both an integer.

In the source driver of the present invention, the source outputs are divided into grouped by setting virtual terminals. The number of the effective output terminal groups is greater than four, and no additional delay unit is needed, so that an EMI test is passed, and waste is avoided. The present invention can make the EMI test passed without changing a size of the source driver, and cost reductions and good EMI test results are achieved.

### BRIEF DESCRIPTION OF DRAWINGS

The following detailed description of specific embodiments will make the technical solutions and other beneficial effects of the present application apparent in conjunction with the accompanying drawings.

FIG. 1 is a schematic view illustrating that effective output terminals of a source driver are divided into six groups by dummy terminals;

FIG. 2 is a schematic view illustrating that the effective output terminals of the source driver are divided into eight groups by the dummy terminals;

FIG. 3 is a schematic view illustrating that the effective output terminals of the source driver are divided into 10 groups by the dummy terminals; and

FIG. 4 is a schematic view illustrating a number of the effective output terminal groups and distribution of radiated energy for different source drivers.

### DETAILED DESCRIPTION OF EMBODIMENTS

Technical solutions of the present invention will be clearly and completely described below with reference to specific embodiments and the accompanying drawings. It is apparent that the embodiments are only some embodiments of the present invention, and not all of the embodiments. All other embodiments obtained by those skilled in the art based on the embodiments of the present invention without an inventive step are deemed to be within the protection scope of the present invention.

In the specification, it should be understood that the terms such as “central”, “longitudinal”, “lateral”, “length”, “width”, “thickness”, “above”, “below”, “front”, “rear”, “left”, “right”, “vertical”, “horizontal”, “top”, “bottom”, “inner”, “outer”, “clockwise”, “counter-clockwise” should be construed to refer to the orientation based on the accompanying drawings. These terms are merely for ease of description and do not alone indicate or imply that the device or element referred to must be set up or operate in a specific orientation. Thus, the present application is not limited by the directional terms. In addition, terms such as “first” and “second” are used for purposes of description and are not intended to indicate or imply relative importance or significance or impliedly indicate quantity of the technical feature referred to. Thus, the feature defined with “first” and “second” may explicitly or implicitly indicate inclusion of one or more this feature. In the description of the present application, “a plurality of” means two or more than two, unless specified otherwise.

In the present application, it should be understood that unless otherwise specified or defined, the terms “mounted,” “connected,” “coupled,” and the like are explained in a broad aspect These terms may indicate, for example, fixed connections, detachable connections, or integral connections; these terms may also refer to mechanical connections, electrical connections, or communication; in some cases, these terms may refer to direct connections or indirect connections via intermediate structures; these terms may even be used when two elements internally communicate with each other, or when two elements interact with each other. For those of ordinary skill in the art, the specific meanings of the above terms can be understood on a case-by-case basis.

In the present application, unless specified or defined otherwise, a first feature is “on” or “below” a second feature may indicate that the first feature is in direct contact with the second feature, and may also indicate that the first feature and the second feature are not in direct contact with each other, but are contacted via an additional feature therebetween. Furthermore, a first feature “over,” “above,” or “on top of” a second feature may indicate that the first feature is right or obliquely “over,” “above,” or “on top of” the second feature, or just mean that the first feature is at a height higher than that of the second feature; while a first feature “below,” “under,” or “on bottom of” a second feature may indicate that the first feature is right or obliquely “below,” “under,” or “on bottom of” the second feature, or just mean that the first feature is at a height lower than that of the second feature.

The present invention is embodied in various embodiments and examples in the following description. In order to simplify the description, elements and configurations of some embodiments are described. However, they are only examples and are not intended to limit the present invention. In addition, reference numerals and/or letters may be repeated in different examples of the present invention. The repetitions are for the purpose of simplification and clarity and do not refer to relations between different embodiments and/or configurations. Furthermore, examples of different processes and materials are provided in the present invention. However, it would be appreciated by those skilled in the art that other processes and/or materials may also be used.

The present invention is directed to solving a problem of a source driver of conventional techniques. If effective output terminal groups of the source driver are divided into a small number of groups, an electro-magnetic interference (EMI) test fails. If the effective output terminal groups of the source driver are divided into many groups, a waste of costs is caused. The present embodiments provide a source driver to solve the above problem.

According to one embodiment of the present invention, a source driver is provided. The source driver comprises an output terminal. The output terminal comprises a plurality of effective output terminals and a plurality of dummy terminals, wherein the effective output terminals constitute a plurality of effective output terminal groups, the dummy terminals constitute a plurality of dummy terminal groups, and the effective output terminal groups are spaced apart by the dummy terminal groups.

A number of the effective output terminal groups is greater than a number of the dummy terminal groups. Some of the effective output terminal groups have a same number of the effective output terminals. Some of the dummy terminal groups have a same number of the dummy terminals. A number of the effective output terminals is greater than a number of the dummy terminals. A number of the effective output terminals is greater than a number of the dummy terminals.

In the present embodiment, the number of the effective output terminal groups is greater than four. That is to say, the number of the effective output terminal groups is six, eight, ten, other odd numbers, or more groups. A number of the dummy terminal groups is one less than the number of the effective output terminals. That is to say, the number of the dummy terminal groups is five, seven, nine, or other number corresponding to the effective output terminal groups.

The present embodiment takes high definition (HD) resolution as an example. The source driver has 1440 output terminals in total, but in fact there are only 1368 output terminals connected to a panel. That is, there are only 1368 effective output terminals, and other 72 terminals are dummy terminals.

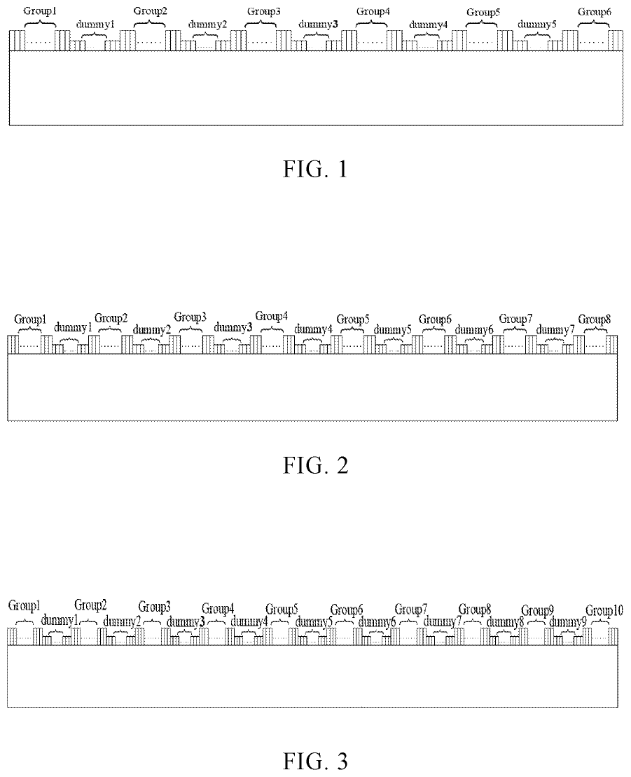

Referring to FIG. 1, FIG. 1 is a schematic view illustrating that the effective output terminals of the source driver are divided into six groups by the dummy terminals. As shown in FIG. 1, the effective output terminals are divided into six groups by the dummy terminals, wherein each effective output terminal group has 228 effective output terminals. There is a dummy terminal group between each two effective output terminal groups, and a total number of the dummy terminal groups is five. The first four dummy terminal groups have 14 dummy terminals, and the last dummy terminal group has 16 dummy terminals.

Referring to FIG. 2, it is a schematic view illustrating that the effective output terminals of the source driver are divided into eight groups by the dummy terminals. As shown in FIG. 2, the effective output terminals of the source driver are divided into eight groups by the dummy terminals, wherein each effective output terminal group has 171 effective output terminals. There is a dummy terminal group between each two effective output terminal groups, and a total number of the dummy terminal groups is seven. The first six dummy terminal groups have 10 dummy terminals, and the last dummy terminal group has 12 dummy terminals.

Referring to FIG. 3, it is a schematic view illustrating that the effective output terminals are divided into 10 groups by the dummy terminals. As shown in FIG. 3, the effective output terminals of the source driver are divided into ten groups by the dummy terminals. Nine effective output terminal groups have 137 effective output terminals, and the last effective output terminal group has 135 effective output terminals. There is a dummy terminal group between each two effective output terminal groups, and a total number of the dummy terminal groups is nine. Each of the dummy terminal groups has eight dummy terminals.

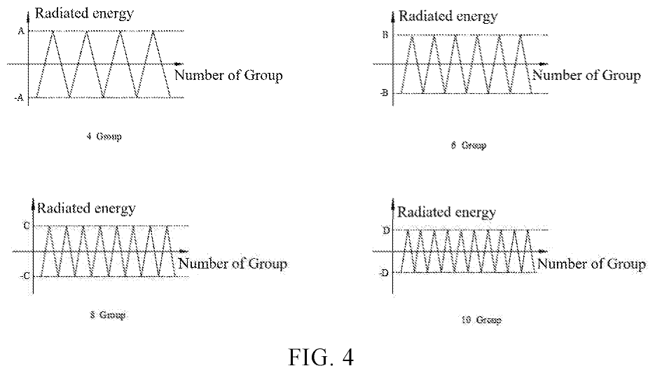

Referring to FIG. 4, it is a schematic view illustrating a number of the effective output terminal groups and distribution of radiated energy for different source drivers. As shown in FIG. 4, on the premise that no additional circuit modules are added to a display driving circuit, when the effective output terminals of the source driver are divided into more groups by the dummy terminals, the energy distribution is more dispersed, and it is easier to pass the EMI test. In detail, 71 dummy terminals divide 1368 effective output terminals acting as output channels into four, six, eight, or 10 effective output terminal groups. FIG. 4 shows the magnitude of radiated energy. When the effective output terminals are divided into four effective output terminal groups, the radiated energy is the most concentrated one, an amplitude A is the largest, and the EMI test is most likely failed. When the effective output terminals are divided into six effective output terminal groups, the radiated energy is more dispersed than the radiated energy of four effective output terminal groups, and an amplitude B is also smaller than the amplitude A, and the EMI test is relatively easier to pass. When the effective output terminals are divided into eight effective output terminal groups, the radiated energy is more dispersed than the radiated energy of six effective output terminal groups, and an amplitude C is also smaller than the amplitude B, and the EMI test is relatively easier to pass. Finally, when the effective output terminals are divided into 10 effective output terminal groups, the radiated energy is the most dispersed one, which is more dispersed than the radiated energy of eight effective output terminal groups, an amplitude D is the smallest, and it is easiest to pass the EMI test.

Advantages of the Present Invention:

In the source driver of the present invention, the source outputs are divided into groups by setting the virtual terminals, the effective output terminal groups are more than the four groups in conventional techniques, and no additional delay unit is required. The present invention can make an EMI test passed and also avoid waste. EMI tests can be passed without changing the size of the source driver, so the present invention achieves cost reductions and good EMI test results.

The source driver of the present invention is described in detail above. The principles and embodiments of the present invention are described in the specific examples, and the foregoing embodiments are only used to help understand the technical solutions of the present invention and its main ideas. Those of ordinary skill in the art should understand that the technical solutions described in the foregoing embodiments may be modified, or some features can be equivalently replaced based on the present disclosure. Such modifications and substitutions are deemed to be within the protection scope of the present invention.

What is claimed is:

1. A source driver, comprising:
an output terminal comprising a plurality of effective output terminals and a plurality of dummy terminals, wherein the effective output terminals constitute a plurality of effective output terminal groups, the dummy terminals constitute a plurality of dummy terminal groups, and the effective output terminal groups are spaced apart by dummy terminal groups;
wherein a number of the effective output terminal groups is greater than a number of the dummy terminal groups, and a number of the effective output terminals is greater than a number of the dummy terminals.

2. The source driver according to claim 1, wherein some of the effective output terminal groups have a same number of the effective output terminals.

3. The source driver according to claim 1, wherein some of the dummy terminal groups have a same number of the dummy terminals.

4. The source driver according to claim 1, wherein the number of the effective output terminal groups is greater than four.

5. The source driver according to claim 1, wherein the number of the effective output terminal groups is six, eight, or ten.

6. The source driver according to claim 4, wherein the number of the dummy terminal groups is one less than a number of the effective output terminals.

7. The source driver according to claim 5, wherein the number of the dummy terminal groups is five, seven, or nine.

8. The source driver according to claim 1, wherein all the effective output terminals are divided equally among the effective output terminal groups, or, if indivisible, a number of the effective output terminals in the last effective output terminal group is reduced; all the dummy terminals are divided equally among the dummy terminal groups, or, if indivisible, a number of the dummy terminals is reduced in the last dummy terminal group; and a number of the effective output terminals in each effective output terminal group and a number of the dummy terminals in each dummy terminal group are both an integer.

9. A source driver, comprising:
an output terminal comprising a plurality of effective output terminals and a plurality of dummy terminals, wherein the effective output terminals constitute a plurality of effective output terminal groups, the dummy terminals constitute a plurality of dummy terminal groups, and the effective output terminal groups are spaced apart by the dummy terminal groups.

10. The source driver according to claim 9, wherein a number of the effective output terminal groups is greater than a number of the dummy terminal groups.

11. The source driver according to claim 9, wherein some of the effective terminal groups have a same number of the effective output terminals.

12. The source driver according to claim 9, wherein some of the dummy terminal groups have a same number of the dummy terminals.

13. The source driver according to claim 9, wherein a number of the effective output terminals is greater than a number of the dummy terminals.

14. The source driver according to claim 9, wherein a number of the effective output terminal groups is greater than four.

15. The source driver according to claim 13, wherein the number of the effective output terminal groups is six, eight, or ten.

16. The source driver according to claim 14, wherein a number of the dummy terminal groups is one less than the number of the effective output terminals.

17. The source driver according to claim 15, wherein a number of the dummy terminal groups is five, seven, or nine.

18. The source driver according to claim 9, wherein all the effective output terminals are divided equally among the effective output terminal groups, or, if indivisible, a number of the effective output terminals in the last effective output terminal group is reduced; all the dummy terminals are divided equally among the dummy terminal groups, or, if indivisible, a number of the dummy terminals in the last dummy terminal group is reduced; and a number of the effective output terminals in each effective output terminal group and a number of the dummy terminals in each dummy terminal group are both an integer.
